(19) United States
(12) Patent Application Publication
(10) Pub. No.: US 2026/0289634 A1
(43) Pub. Date: Sep. 24, 2026

(54) INFORMATION PROCESSING APPARATUS AND INFORMATION PROCESSING METHOD

(71) Applicant: TOYOTA JIDOSHA KABUSHIKI KAISHA, Toyota-shi Aichi-ken (JP)

(72) Inventor: Keisuke SANO, Toyota-shi Aichi-ken (JP)

(73) Assignee: TOYOTA JIDOSHA KABUSHIKI KAISHA, Toyota-shi Aichi-ken (JP)

(21) Appl. No.: 19/418,204

(22) Filed: Dec. 12, 2025

(30) Foreign Application Priority Data
Mar. 24, 2025 (JP) 2025-049056

(51) Int. Cl. G06Q 30/0601; G07C 5/02

(52) U.S. Cl. CPC G06Q 30/0631; G07C 5/02

(57) ABSTRACT

An information processing apparatus comprising a controller, the controller being configured to execute obtaining the total travel distance from the start of vehicle use by the user until replacement, obtaining statistical values of the a travel distance per trip by the user in the vehicle, determining the recommended drive system for purchase for the user from multiple drive systems, including the plug-in hybrid system and the hybrid system, according to the priority of recommended drive systems determined based on the total travel distance and the statistical values, and outputting information indicating the recommended drive system. The priority is determined at least according to the sum of carbon dioxide emissions from manufacturing and driving. When the statistical value exceeds the first threshold, the priority of the plug-in hybrid system is lower than that of the hybrid system.

### CROSS REFERENCE TO THE RELATED APPLICATION

This application claims the benefit of Japanese Patent Application No. 2025-049056, filed on Mar. 24, 2025, which is hereby incorporated by reference herein in its entirety.

### BACKGROUND

### Technical Field

The present disclosure relates to an information processing apparatus and information processing method.

### Description of the Related Art

Patent Literature 1 (Japanese Patent Laid-Open No. 2021-092841) discloses an information processing apparatus. The controller of the information processing apparatus disclosed in Patent Literature 1 determines, based on the driving data of the vehicle driven by the customer, whether to make the specifications of the proposed vehicle, which is suggested to the customer, an electric vehicle. Then, the controller of the information processing apparatus outputs the determined specifications.

### SUMMARY

An object of the present disclosure is to propose a drive system to the user that suppresses the total carbon dioxide emissions according to the actual usage of the user's vehicle.

One aspect of the present disclosure is an information processing apparatus comprising a controller, the controller being configured to execute:

obtaining the total travel distance from the start of vehicle use by the user until replacement,

obtaining statistical values of the a travel distance per trip by the user in the vehicle,

determining the recommended drive system for purchase for the user from multiple drive systems, including the plug-in hybrid system and the hybrid system, according to the priority of recommended drive systems determined based on the total travel distance and the statistical values, and

outputting information indicating the recommended drive system,

wherein the priority is determined at least according to the sum of carbon dioxide emissions from manufacturing and driving, and

when the statistical value exceeds the first threshold, the priority of the plug-in hybrid system is lower than that of the hybrid system.

One aspect of the present disclosure is an information processing method, wherein computer executes:

obtaining the total travel distance from the start of vehicle use by the user until replacement,

obtaining statistical values of the a travel distance per trip by the user in the vehicle,

determining the recommended drive system for purchase for the user from multiple drive systems, including the plug-in hybrid system and the hybrid system, according to the priority of recommended drive systems determined based on the total travel distance and the statistical values, and

outputting information indicating the recommended drive system,

wherein the priority is determined at least according to the sum of carbon dioxide emissions from manufacturing and driving, and

when the statistical value exceeds the first threshold, the priority of the plug-in hybrid system is lower than that of the hybrid system.

According to the present disclosure, it is possible to propose a drive system to the user that suppresses the total carbon dioxide emissions according to the actual usage of the user's vehicle.

### BRIEF DESCRIPTION OF THE DRAWINGS

FIG. 1 indicates a schematic configuration of the information system of the present disclosure;

FIG. 2 indicates a schematic configuration of the proposal server included in the information system;

FIG. 3 indicates the correlation between total travel distance and total emissions according to the drive system;

FIG. 4 indicates the priority order of recommended drive system to purchase based on total travel distance and statistical values;

FIG. 5 indicates the correlation between total travel distance and total cost according to the drive system; and

FIG. 6 is a flowchart indicating the process flow for determining the drive system recommended for purchase to the user.

### DESCRIPTION OF THE EMBODIMENTS

Assuming a case where, from multiple drive systems for a vehicle, the drive system recommended for purchase to the user is determined according to the total carbon dioxide emissions (at least the sum of carbon dioxide emissions from manufacturing and those from driving). In this case, the multiple drive system include plug-in hybrid system and hybrid system.

Here, the manufacturing of vehicles with the plug-in hybrid system results in higher carbon dioxide emissions compared to vehicles with the hybrid system due to differences such as the number of parts. Moreover, between plug-in hybrid system vehicle and hybrid system vehicle, carbon dioxide emissions from driving are higher for the hybrid vehicle. Therefore, as the total travel distance increases, the difference in carbon dioxide emissions from vehicle manufacturing between plug-in hybrid system vehicle and hybrid system diminishes, and eventually, the total carbon dioxide emissions reverse.

In other words, the total carbon dioxide emissions differ between the plug-in hybrid system and the hybrid system depending on the total travel distance.

Similarly, even when drive system other than plug-in hybrid system and hybrid system are included, the total carbon dioxide emissions may be reversed due to the difference between carbon dioxide emissions from manufacturing and those from driving.

On the other hand, in the case of plug-in hybrid system, electric energy supplied from an external power source is used. When the rate of use of externally supplied electricity during a single trip of a plug-in hybrid system vehicle is low, the engine operates for a longer period compared to when the rate of use of externally supplied electricity is high, resulting in higher carbon dioxide emissions from driving. In other words, when the travel distance per trip becomes longer, the vehicle runs without receiving electricity supply from an external power source, thus the engine operates longer and the carbon dioxide emissions from driving become greater compared to the case when the travel distance per trip is short. As a result, it becomes difficult to close the gap in carbon dioxide emissions from manufacturing between the plug-in hybrid system and the hybrid system, and to reverse the total carbon dioxide emissions. Therefore, if the user tends to have longer travel distances per trip, the hybrid system can reduce the total carbon dioxide emissions more effectively than the plug-in hybrid system.

In this way, by setting the priority of the recommended drive system according to the total vehicle mileage and the travel distance per trip, it is possible to recommend the purchase of the drive system that corresponds better to the total carbon dioxide emissions. Therefore, the priority of the recommended drive system for purchase is determined according to the total amount of carbon dioxide emissions, and when the statistical value of the user's travel distance per vehicle trip exceeds the first threshold, the plug-in hybrid system is set to have a lower priority than the hybrid system. Here, the first threshold is a predetermined value (travel distance) that makes it difficult to reverse the total amount of carbon dioxide emissions between the plug-in hybrid system and the hybrid system.

Then, the controller of the information processing apparatus according to present disclosure obtains the total travel distance from the start of vehicle use by the user up to its replacement. Furthermore, the controller of the information processing apparatus according to the present disclosure acquires the statistical value of the user's travel distance per vehicle trip. The controller of the information processing apparatus determines the recommended drive system for purchase for the user from multiple drive systems including the plug-in hybrid system and hybrid system, according to the priority of the recommended drive systems for purchase determined based on the total travel distance and statistics. Then, the controller of the information processing apparatus outputs information indicating the recommended drive system for purchase. Here, the priority is determined at least according to the sum of the carbon dioxide emissions from manufacturing and the total carbon dioxide emissions from travel. Also, when the statistical value exceeds the first threshold, the plug-in hybrid system has a lower priority than the hybrid system.

As explained above, the information processing apparatus can determine the recommended drive system for purchase according to the priority based on the statistical values of the total travel distance and the travel distance per trip. At this time, when the statistical value of the travel distance per trip exceeds the first threshold, the priority of the plug-in hybrid system is set to be lower than that of the hybrid system. This allows for proposing a drive system to the user that suppresses the total carbon dioxide emissions according to the actual usage of the user's vehicle.

Specific embodiments of the present disclosure will be described below on the basis of the drawings. The hardware configurations, module configurations, functional configurations, and the like described in each embodiment are not intended to limit the technical scope of the disclosure to these alone unless otherwise specified.

### embodiment

### System Overview

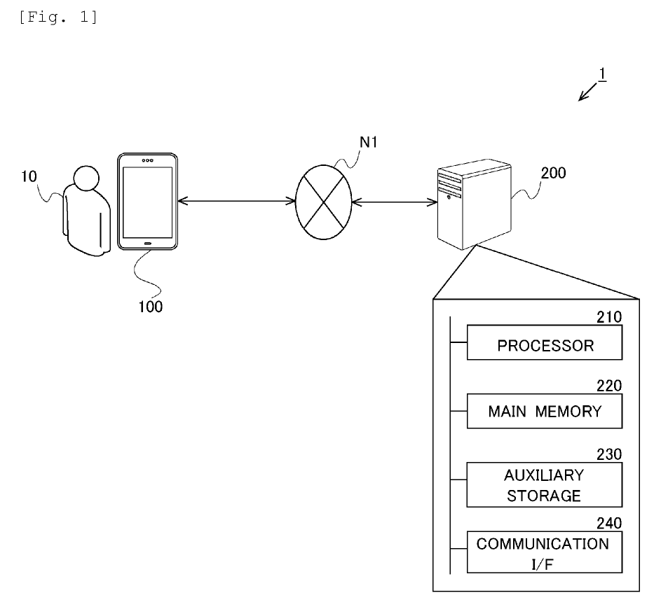

The information system 1 in the present embodiment will be described based on FIG. 1. FIG. 1 indicates a schematic configuration of the information system 1. The information system 1 is configured to include a user terminal 100 and a proposal server 200. In the information system 1, the user terminal 100 and the proposal server 200 are connected to each other via a network N1. The network N1 may, for example, adopt a WAN (Wide Area Network), which is a global public communication network such as the Internet, or a telephone communication network such as a mobile phone network.

### User terminal

User terminal 100 is a terminal used by user 10. Examples of user terminal 100 include a computer or a mobile information terminal used by user 10. Here, user 10 is the user considering replacing the vehicle. The replacement of the vehicle includes, for example, buying a new vehicle or refinancing. When user 10 intends to replace the vehicle, they use user terminal 100 to connect to proposal server 200.

At that time, user 10 inputs the method for determining the desired drive system (hereinafter sometimes simply referred to as "the determination method") into the user terminal 100. Here, as the determination method for the drive system, three types of determination methods are selected: a method that considers environmental aspects, a method that considers both environmental aspects and convenience, and a method that considers both environmental aspects and economic efficiency. Here, if a determination method considering convenience along with environmental factors or a determination method considering economic factors along with environmental factors is not selected, a determination method that considers environmental factors will be automatically chosen.

The user terminal 100 connects to the proposal server 200 via the network N1 in response to the operation by the user 10. Then, user terminal 100 acquires the total travel distance from the start of using the vehicle by user 10 to the replacement (hereinafter simply referred to as "total travel distance"). For example, user terminal 100 obtains the current travel distance from the vehicle. Alternatively, user terminal 100 may acquire the total travel distance by user 10 inputting the current travel distance, for example. Also, when the user 10 does not immediately replace the vehicle, the user terminal 100 may predict the total travel distance at the time of the vehicle replacement from the current travel distance of the vehicle and the timing of the vehicle replacement.

Additionally, the user terminal 100 acquires statistical values of the travel distance per trip of the vehicle (hereinafter sometimes simply referred to as "statistical values"). Here, the statistical values are, for example, the average travel distance of the vehicle. The statistical values may also be, for example, the median or mode of the travel distance per trip of the vehicle. The user terminal 100, for example, acquires data on the travel distance from the vehicle and calculates the statistical values. Also, user 10 may obtain statistical values by inputting statistical data on the travel distance.

Also, the user terminal 100 calculates the proportion of time that the vehicle has been driven exceeding the second threshold during a unit period (hereinafter sometimes referred to as "exceedance ratio"). Here, the unit period is, for example, the period from the start of using the vehicle until the present. Also, the unit period may be the most recent stipulated period. Details regarding the second threshold and the excess ratio will be described later.

The user terminal 100 transmits, via the network N1, the acquired information including the determination method, total travel distance, statistical values, and exceedance ratio (hereinafter sometimes referred to as "driving information") to the proposal server 200.

### Proposal server

The proposal server 200 is a server that provides information about the drive system of vehicles recommended for purchase to the user 10, based on driving information transmitted from the user terminal 100. The proposal server 200 refers to the driving information and determines the drive system recommended for purchase to the user 10 from multiple drive systems, based on the total emission of carbon dioxide (hereinafter sometimes simply referred to as "total emission") and according to the decision method selected by the user 10.

Here, multiple drive systems refer to five types: the engine system, hybrid system (HEV system), plug-in hybrid system (PHEV system), battery electric system (BEV system), and hydrogen fuel cell system (FCEV system). Total emissions refer to the emissions that include carbon dioxide emissions from manufacturing and carbon dioxide emissions from driving. Carbon dioxide emissions from manufacturing include emissions from parts assembly and parts transportation, as well as emissions from raw material mining and refining processes. Additionally, carbon dioxide emissions during driving include the amount of carbon dioxide emitted by the vehicle while driving, as well as the carbon dioxide emissions associated with producing the driving energy (such as the manufacture of fossil fuels, hydrogen production, and power generation). In addition, the total emissions may include the carbon dioxide generated when disposing of vehicle.

Details about the method in which proposal server 200 determines the drive system to recommend for purchase to user 10, based on the total emission volume and according to the decision method selected by user 10 from multiple drive systems, will be described later.

The proposal server 200 is comprised of a computer including a processor 210, a main memory 220, an auxiliary storage 230, and a communication interface (communication I/F) 240. The processor 210 is, for example, a CPU (Central Processing Unit) or a DSP (Digital Signal Processor). The main memory 220 is, for example, RAM (Random Access Memory). The auxiliary storage 230 is, for example, ROM (Read Only Memory). Also, the auxiliary storage 230 is a disk recording medium such as an HDD (Hard Disk Drive), or a CD-ROM, DVD disk, or Blu-ray disk. Additionally, the auxiliary storage 230 may be a removable media (portable storage medium). Here, for removable media, a USB memory or an SD card is given as an example. The communication I/F 240 is, for example, a LAN (Local Area Network) interface board or a wireless communication circuit for wireless communication.

In the proposal server 200, the auxiliary storage 230 stores the operating system (OS), various types of programs, and various information tables, etc. Also, in the proposal server 200, the processor 210 can realize various functions as described later by loading and executing the program stored in the auxiliary storage 230 into the main memory 220. However, some or all functions in the proposal server 200 may be implemented by hardware circuits such as ASIC or FPGA. Note that the proposed server 200 does not necessarily have to be realized by a single physical configuration and may be composed of multiple computers working in cooperation with each other. Also, the user terminal 100, like the proposed server 200, is configured to include a computer.

### Functional Configuration

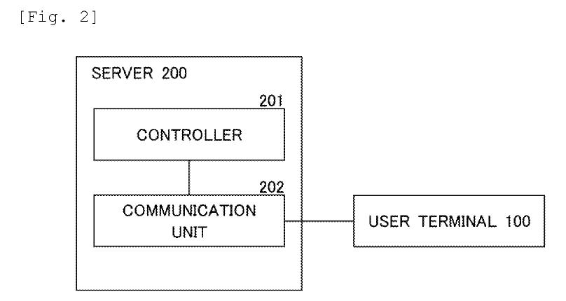

Next, the functional configuration of the proposal server 200, which constitutes information system 1, will be explained based on FIG. 2. FIG. 2 is a block diagram that schematically indicates an example of the functional configuration of the proposal server 200.

Proposal server 200 is configured to include a controller 201 and a communication unit 202. The controller 201 has a function to perform computational processing to control the proposal server 200. The controller 201 can be realized by the processor 210 in the proposed server 200. The communication unit 202 has a function to connect the proposal server 200 to the network. The communication unit 202 can be realized by the communication I/F 240 in the proposal server 200.

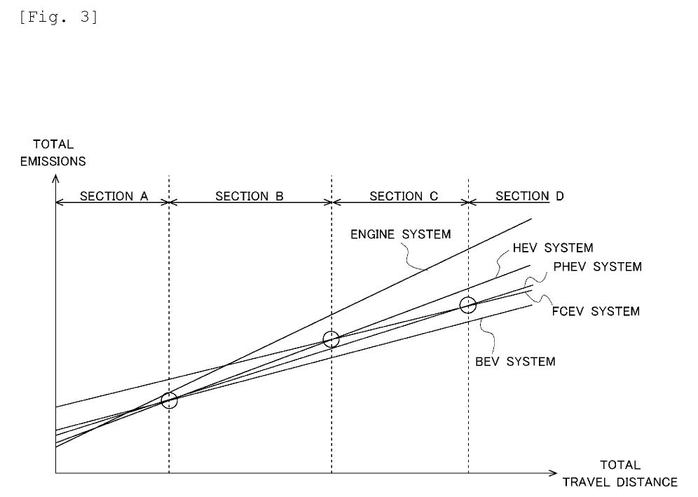

The controller 201 receives driving information from the user terminal 100 via the communication unit 202. The controller 201 determines a drive system to be recommended to the user 10 for purchase, based on the driving information. Here, FIG. 3 is a diagram indicating exemplarily the relationship between the total travel distance and the total carbon dioxide emissions for each drive system (engine system, HEV system, PHEV system, BEV system, FCEV system). FIG. 3, the horizontal axis represents the total travel distance. The total travel distance is defined as the accumulated travel distance traveled starting from the completion of the vehicle manufacturing. In addition, in FIG. 3, the vertical axis indicates the total amount of carbon dioxide emissions, including those from the vehicle manufacturing process.

Here, the intercepts of the lines for each drive system in FIG. 3 (total emissions when the total travel distance is zero) represent the amount of carbon dioxide emissions at the stage when the vehicle has not yet traveled, and therefore do not include carbon dioxide emissions from driving. Therefore, the intercepts of the lines for each drive system indicates the carbon dioxide emissions during the manufacturing stage. In general, the FCEV system tends to emit a large amount of carbon dioxide due to the manufacturing of fuel cells, and the BEV system tends to emit a large amount of carbon dioxide due to the manufacturing of batteries. In addition, the PHEV and HEV system use smaller-scale batteries compared to the FCEV and BEV systems, so although their carbon dioxide emissions are lower, they still exceed those of engine system. Then, when comparing the PHEV system and the HEV system, the PHEV system tends to have a larger number of components, which results in a higher amount of carbon dioxide emissions. Based on these considerations, as indicated in FIG. 3, the amount of carbon dioxide emissions from manufacturing decreases in the order of engine system, HEV system, PHEV system, BEV system, and FCEV system.

On the other hand, the amount of carbon dioxide emissions from driving varies depending on each drive system. During the driving phase, the amount of carbon dioxide emitted per unit distance (corresponding to the slope of the straight lines indicated in FIG. 3 for each drive system) is highest for the engine system, followed in decreasing order by the HEV system, PHEV system, BEV system, and FCEV system. Therefore, as the total travel distance increases, the differences in total emissions among the drive system during the manufacturing phase become narrower, and in some cases, the order of total emissions may reverse.

Here, focusing on the variation in the order of total emissions for each drive system, the total travel distance in FIG. 3 is divided into four representative sections, A to D, and the details of each section are described below. Section A is the period when the vehicle usage has just started and the total travel distance is still short. In section A, focusing on the two with the least total emissions during the manufacturing stage, the HEV system and the engine system, the total emissions for the engine system are smaller than those of the HEV system from a travel distance of zero to about the middle of section A. However, after the middle of section A, this reverses, and the total emissions of the HEV system become smaller. After that, the state where the total emission in the HEV system is the lowest continues, reaching the end of section A (the boundary between section A and section B). Therefore, for section A, attention is focused on the total emission after the reversal between the HEV system and the engine system.

Also, at the boundary between section A and section B, a reversal in the total emissions occurs among the HEV system, PHEV system, and BEV system (see the circled part on the left side in the figure). Therefore, Section B is defined as the period after this reversal in the order of total emissions between these drive system until the start of Section C, which will be described later. In the middle of Section B, the total emissions of the engine system exceed those of the FCEV system, becoming the largest, and thereafter, the total emissions of the engine system remain greater than those of the other drive system. Therefore, for section B, we focus on the total emissions starting from the point where the engine system has the highest total emissions. The total emissions, in ascending order, are as follows: BEV system, PHEV system, HEV system, FCEV system, and engine system.

Also, at the boundary between section B and section C, a reversal in total emissions occurs between the HEV system and the FCEV system (see the circled part in the center of the figure). Therefore, Section C is defined as the period after the reversal of the order of total emissions among these drive system and before the start of Section D, which will be described later. And in Section C, the total emissions are ranked from smallest to largest as follows: BEV system, PHEV system, FCEV system, HEV system, and engine system.

Also, at the boundary between Section C and Section D, a reversal in total emissions occurs between the PHEV system and the FCEV system (see the circled part on the left side of the figure). Therefore, Section D is defined as the period following the reversal of the order of total emissions among these drive system. And in Section D, the total emissions are ranked from smallest to largest as follows: BEV system, FCEV system, PHEV system, HEV system, and engine system.

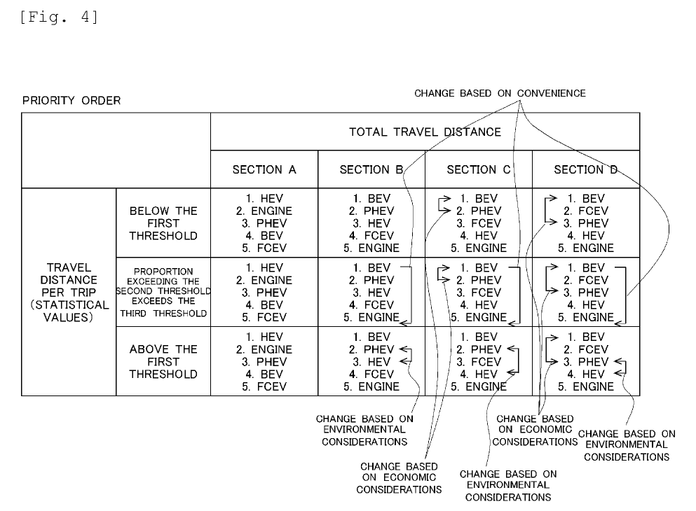

Based on the above, the controller 201 is configured, in principle, to determine the priority order of the recommended drive system for purchase, sorted in ascending order of the total emissions defined for each section. FIG. 4 is a table indicating the priority order of drive system recommended for purchase, determined according to the total travel distance and statistical values. As indicated in FIG. 4, in Section A, the priority order is determined as HEV system, engine system, PHEV system, BEV system, and FCEV system. Also, in section B, the priority order is determined as BEV system, PHEV system, HEV system, FCEV system, and engine system. Also, in section C, the priority order is determined as BEV system, PHEV system, FCEV system, HEV system, and engine system. Also, in section D, the priority order is determined as BEV system, FCEV system, PHEV system, HEV system, and engine system.

Here, we will further examine vehicle using the PHEV system from an environmental perspective. Vehicle using the PHEV system utilize electricity supplied from external sources. However, the longer the travel distance of a vehicle using the PHEV system, the smaller the proportion of driving using externally supplied electricity becomes, and the larger the proportion of driving using fossil fuels becomes. In that case, the carbon dioxide emissions per unit of travel distance will approach those of the HEV system. Therefore, when a PHEV- system vehicle is driven over long distances, it may not be possible to offset the difference in carbon dioxide emissions from manufacturing between PHEV and HEV systems. In this case, even if a PHEV-system vehicle is purchased, the total emissions will not be lower than those of an HEV-system vehicle.

Therefore, if the travel distance per trip (statistical value) exceeds the first threshold, the priority between the PHEV system and the HEV system is reversed. In this way, the PHEV system is set to have a lower priority than the HEV system. Here, the first threshold is the statistical value of the travel distance per trip at which it is assumed that the difference in carbon dioxide emissions due to manufacturing between the PHEV system and the HEV system can no longer be compensated by the carbon dioxide emissions from driving. Specifically, when the total travel distance is in sections B, C, and D, and the statistical value exceeds the first threshold, the priority between the PHEV system and the HEV system is reversed (refer to "Change based on environmental considerations" in FIG. 4).

In this way, by considering environmental characteristics (total emissions) and if the travel distance per trip (statistical value) exceeds the first threshold, the priority between the PHEV system and HEV system is reversed, and the drive system recommended for user 10 to purchase is determined.

Here, there are cases where user 10 tries to select the drive system by taking both environmental characteristics and convenience into account. Therefore, focus is placed on the BEV-system vehicle. For BEV-system vehicle, the longer the travel distance per trip, the more often charging is required, which reduces convenience. Therefore, when user 10 selects a drive system considering convenience, if the proportion of trips where the travel distance per trip (statistical value) exceeds the second threshold surpasses the third threshold within a given period, the priority of the BEV system is set to the lowest due to decreased convenience. Here, the unit period is a predetermined length of time, such as one month. Also, the second threshold represents the travel distance at which BEV-system vehicle is assumed to need to charge. In addition, the third threshold represents the proportion at which user is assumed to feel inconvenienced if they charge within a given time period.

Specifically, if the proportion of statistical values exceeding the second threshold exceeds the third threshold, the priority of the BEV-system is set to the lowest in sections A, B, C, and D of the travel distance (see "Change based on convenience" in FIG. 4).In addition, taking into account the correlation with the "environmental change" mentioned above, if the first threshold is greater than the second threshold, the priority of the BEV system in sections A, B, C, and D where the statistical value exceeds the first threshold may be set to the lowest.

In this way, when user 10 tries to select a drive system considering convenience, the priority of the BEV system is set to the lowest when the proportion of statistical values exceeding the second threshold surpasses the third threshold, and the drive system recommended for user 10 to purchase is determined.

Also, there are cases where user 10 tries to select a drive system considering economic efficiency. In other words, there are cases where the user 10 tries to select a drive system by considering the sum of the vehicle purchase price and the running costs (total cost) required for driving. Here, the vehicle cost (purchase price) varies depending on the drive system. Also, the vehicle fuel cost, which is the cost of driving energy (fossil fuel, hydrogen, electricity) required for operation, varies depending on the drive system. Therefore, the relationship between total cost and total travel distance differs depending on the drive system.

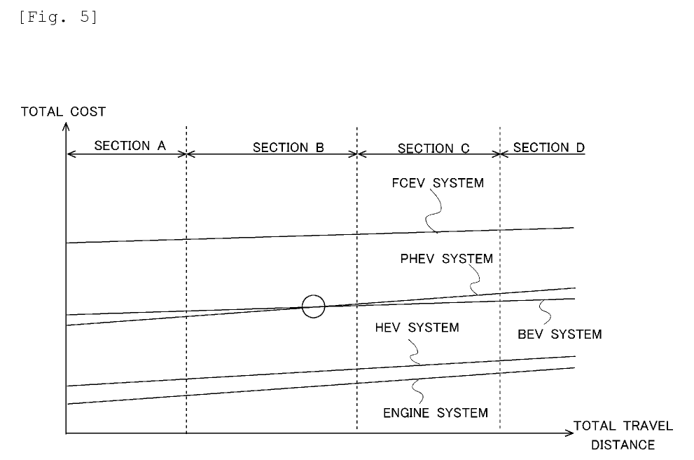

FIG. 5 indicates an example of the relationship between the total cost and the total travel distance for each drive system. In FIG. 5, the horizontal axis represents the total travel distance. Additionally, in FIG. 5, the vertical axis indicates the total cost.

Here, the intercept of the lines for each drive system (the total cost when the total travel distance is zero) represent the total cost at the stage when the vehicle has not been driven, so the cost of driving energy is not included. Therefore, the intercept of the line for each drive system indicates the vehicle cost at the manufacturing stage, with vehicle costs decreasing in the order of FCEV system, BEV system, PHEV system, HEV system, and engine system.

On the other hand, the cost of drive energy varies depending on each drive system. For example, the hydrogen fuel used in the FCEV system is relatively expensive, so the total cost tends to be higher compared to other drive system. Also, with the PHEV system, since both the battery and engine are used, the cost of driving energy per unit distance is higher than that of the BEV system. Therefore, as the total travel distance increases, the difference in vehicle costs between the PHEV system and the BEV system narrows and the vehicle costs reverse. In the example indicated in FIG. 5, the vehicle costs between the PHEV system and the BEV system reverse midway through section B (see the circled part in the figure).

Thus, when the total travel distance corresponds to sections C and D, the priority between the PHEV system and the BEV system is switched. As a result, the priority of the PHEV system is set higher than that of the BEV system.

In this way, when user 10 attempts to select the drive system considering economic efficiency, the priority between the PHEV system and the BEV system is switched for total travel distance in sections C and D, and the drive system recommended for purchase to user 10 is determined (see "Change based on economic efficiency" in FIG. 4).

Additionally, in some regions, purchase subsidies are provided for vehicle with specific drive system. Also, depending on the region, the cost of the drive energy used by a specific drive system may differ due to differences in the extraction or transportation costs of the drive energy. Therefore, the purchase price of the vehicle or the cost of drive energy per unit distance driven may vary depending on the region. Therefore, as the travel distance increases, in cases where there is a reversal in the total cost between a certain drive system (first drive system) and a second drive system with a lower vehicle cost than the first drive system, the priority of the first drive system shall be higher than that of the second drive system when the total travel distance is longer than the travel distance where the reversal in total cost occurred. In this way, a priority is set considering both environmental factors and economic efficiency.

### Flowchart

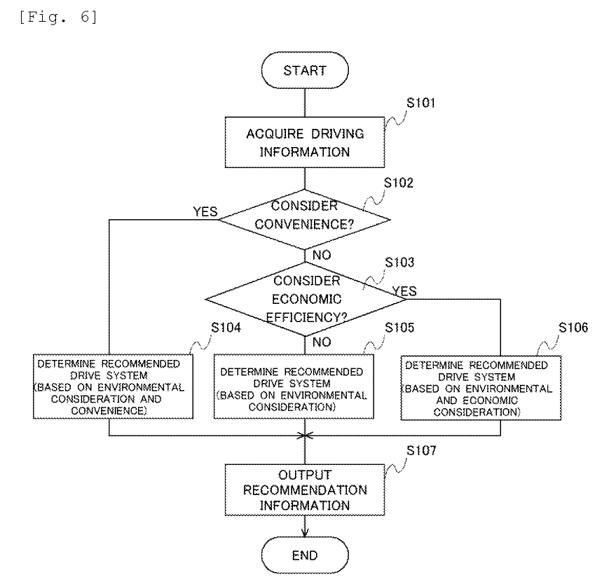

Next, the process executed by the controller 201 in the proposal server 200 within the information system 1 will be explained based on FIG. 6. FIG. 6 is a flowchart of the process executed by the controller 201. The process indicated in FIG. 6 is intended to recommend to the user 10 the purchase of a vehicle with a suitable drive system. The process indicated in FIG. 6 starts when the proposal server 200 receives driving information from the user terminal 100.

In the process indicated in FIG. 6, first, in step S101, driving information received from the user terminal 100 is acquired. Next, in step S102, it is determined whether a decision method considering convenience has been selected by the user 10 from the driving information acquired in S101. If an affirmative determination is made in S102, the user 10 desires a decision method for the drive system that considers convenience along with environmental aspects. Therefore, in S104, the drive system recommended for purchase is determined based on the total travel distance included in the driving information and statistical values, considering convenience by the above method. In other words, the recommended drive system to be purchased is determined according to the priority order reflecting a change based on environmental considerations and convenience. It is also acceptable to determine the recommended drive system to be purchased according to the priority order reflecting a change based on convenience without making a change based on environmental considerations.

The controller 201 decides on the recommended drive system for purchase, for example, by selecting a drive system that ranks within the top three priority levels. Next, at S107, recommendation information indicating the decided recommended drive system for purchase is output to the user terminal 100. Then, the process indicated in FIG. 6 is completed.

If a negative determination is made at S102, the user 10 does not wish to use a drive system that takes convenience into consideration. Therefore, in S103, it is determined whether the selection method considering economic efficiency has been chosen by user 10 for the driving information acquired in S101. If a positive judgment is made in S103, it means that user 10 desires a method for deciding the drive system that takes both environmental and economic factors into account. Then, in S106, based on the total travel distance included in the driving information and statistical data, the drive system recommended for purchase considering convenience is determined by the above-mentioned method. In other words, the recommended drive system for purchase is determined according to the priority order after applying changes based on environmental considerations and economic considerations. Alternatively, the recommended drive system for purchase may be determined according to the priority order after applying a change based on economic considerations without applying a change based on environmental considerations. Next, in S107, the recommended information indicating the decided recommended drive system for purchase is output to the user terminal 100. Then, the process indicated in FIG. 6 is terminated.

If a negative determination is made in S103, the user 10 does not desire a method for determining the drive system that considers convenience and economy. Therefore, in S105, based on the total travel distance included in the driving information and statistical data, the drive system for purchase recommendation that considers environmental factors is determined by the above method. Next, in S107, recommendation information indicating the determined recommended drive system for purchase is output to the user terminal 100. Then, the process indicated in FIG. 6 is completed.

As explained above, in information system 1, the recommended drive system for purchase can be determined based on the total travel distance and priority according to statistical values. Also, the drive system can be determined according to the decision method desired by the user 10 at that time. As a result, it is possible to propose to the user a drive system that suppresses the total carbon dioxide emissions according to the actual usage conditions of the user's vehicle and the user's preferences.

### Modification 1

In this embodiment, if the statistical value exceeds the first threshold, the priority order between the PHEV system and the HEV system is reversed. However, when the statistical value exceeds the first threshold, the PHEV drive system may be excluded from the list of priorities, and the priority of the PHEV drive system may be set lower than that of the HEV drive system. In addition, in this embodiment, when the ratio of the statistical value exceeding the second threshold surpasses the third threshold, the priority of the BEV drive system is set to the lowest. However, if the proportion of statistical values exceeding the second threshold surpasses the third threshold, the BEV drive system may be excluded from the priority list and its priority may be set to the lowest rank. In this way, it is possible to propose to the user a drive system that suppresses the total carbon dioxide emissions according to the actual usage of the user's vehicle.

### Other embodiment

The above embodiment is merely an example, and present disclosure can be implemented with appropriate modifications as long as they do not deviate from the essence thereof. Also, the processes and techniques described in present disclosure can be freely combined and implemented as long as no technical contradictions arise.

Also, the processes described as being performed by a single device may be divided and executed by multiple devices. Alternatively, the processes described as being performed by different devices may be executed by a single device. In computer systems, the implementation of each function with specific hardware configurations (server setups) can be flexibly changed.

The present disclosure can also be realized by supplying a computer program that implements the functions described in the above embodiment to a computer, and the one or more processor of the computer reading and executing the program. Such a computer program may be provided to the computer via a non-transitory computer-readable storage medium connected to the computer's system bus or provided to the computer via a network. Non-transitory computer-readable storage media include, for example, any type of disk such as magnetic disks (floppy disks or hard disk drives (HDDs)), optical disks (CD-ROMs, DVD discs, or Blu-ray discs, etc.), read-only memory (ROM), random access memory (RAM), EPROM, EEPROM, magnetic cards, flash memory, or optical cards,—any type of medium suitable for storing electronic instructions.

What is claimed is:

1. An information processing apparatus comprising a controller, the controller being configured to execute:
obtaining a total travel distance from a start of a vehicle use by a user until replacement,
obtaining statistical values of a travel distance per trip by the user in the vehicle,
determining a recommended drive system for purchase for the user from multiple drive systems, including a plug-in hybrid system and a hybrid system, according to a priority of recommended drive systems determined based on the total travel distance and the statistical values, and
outputting information indicating the recommended drive system,
wherein the priority is determined at least according to a sum of carbon dioxide emissions from manufacturing and driving, and
when the statistical value exceeds the first threshold, a priority of the plug-in hybrid system is lower than that of the hybrid system.

2. The information processing apparatus according to claim 1, wherein
the multiple drive systems include a battery electric system, and
the controller being configured to execute:
obtaining proportion of time during which the vehicle travel exceeds a second threshold within a unit period, and
when the proportion exceeds a third threshold, the battery electric system is ranked lowest in the priority order.

3. The information processing apparatus according to claim 1, wherein
as the travel distance increases, in a case where there is a reversal in a total cost which is a sum of a vehicle cost and a running cost between a first drive system and a second drive system having a lower vehicle cost than the first drive system, when the total travel distance is longer than a travel distance at which the reversal of the total cost occurred, the first drive system ranks higher than the second drive system in the priority order.

4. The information processing apparatus according to claim 2, wherein
the controller being configured to further execute:
obtaining a determination method for the drive system desired by the user, and
the recommended drive system for purchase is determined according to the priority corresponding to the determination method.

5. The information processing apparatus according to claim 3, wherein
the controller being configured to further execute:
obtaining a determination method for the drive system desired by the user, and
the recommended drive system for purchase is determined according to the priority corresponding to the determination method.

6. An information processing method, wherein computer executes:
obtaining a total travel distance from a start of a vehicle use by a user until replacement,
obtaining statistical values of a travel distance per trip by the user in the vehicle,
determining a recommended drive system for purchase for the user from multiple drive systems, including a plug-in hybrid system and a hybrid system, according to a priority of recommended drive systems determined based on the total travel distance and the statistical values, and
outputting information indicating the recommended drive system,
wherein the priority is determined at least according to a sum of carbon dioxide emissions from manufacturing and driving, and
when the statistical value exceeds a first threshold, the priority of the plug-in hybrid system is lower than that of the hybrid system.
